(19) United States
(12) Patent Application Publication
(10) Pub. No.: US 2017/0329283 A1
(43) Pub. Date: Nov. 16, 2017

(54) DIGITAL-TO-DIGITAL CORRECTION UNIT FOR ANALOG CLOCK DISPLAY

(71) Applicant: Charles Richard Bird, SALINE, MI (US)

(72) Inventor: Charles Richard Bird, SALINE, MI (US)

(21) Appl. No.: 15/153,804

(22) Filed: May 13, 2016

(51) Int. Cl. G04C 13/02

(52) U.S. Cl. CPC G04C 13/02

(57) ABSTRACT

A clock device for timekeeping with an analog display and a time correction unit. The time correction unit uses encoder disks and rotary encoders to convert the angular position of the minute hand and the hour hand to a slave time code. The slave time code is compared to a master time code. A feedback circuit drives the minute hand and hour hand drive-motor(s) until the slave time code equals the master time code. The master time code can be generated from a digital clockworks, or it can be transmitted to the present invention from another clock. The invention can be extended to include a second hand and a time correction unit for a second hand.

### FIELD OF INVENTION

This invention relates to the class of horology. Specifically, this invention relates to chronology and chronographs.

### BACKGROUND OF INVENTION

The clock is one of the oldest human inventions, with time-keeping mechanisms, such as sun-dials and water clocks, pre-dating history. Major advancements in the precision of time-keeping occurred in the 1300s with the invention of the mechanical escapement, the 1500s with the invention of the mechanical spring-driven clock, and the 1600s with the pendulum clock.

Clocks existed significantly before clock faces or dials. The first mechanical clocks were striking clocks, designed to ring on the hour. The clock dial with an hour hand came into use in the late 1300s. The minute hand only came into widespread use around 1690, after the invention of the pendulum and anchor escapement. The direction of motion of the clock hands about the face, so-called clockwise, imitate the movement of the sundial in the northern hemisphere. The analog clock face, with an hour hand, minute hand, and twelve hours laid in a circle, has remained largely unchanged for three hundred years or more. There is a substantial preference for the simplicity and aesthetics of the analog clock face.

A mechanical clock relies on the inner mechanical spring-loaded clockwork, or a pendulum, to stabilize the period of oscillation, which is how a mechanical clock maintains accurate time. But friction robs these mechanical oscillators of a tiny bit of energy on every stroke. As the aggregate energy loss increases, the oscillations slow, leading to deteriorating accuracy for the clock. A mainspring or pendulum is designed to counterbalance this effect, continually adding stored energy to the system to keep things on track. But a mainspring or pendulum is not an infinite source of additive energy; in a mainspring clockwork, the clock must be wound periodically; in a pendulum clock, the anchor escapement has to be reset periodically. As an alternative, an electronic source can add energy to the mechanical clock.

There are also fully electronic movements, such as piezoelectric crystal oscillators, which use a piezoelectric quartz crystal to generate an electrical signal with a specific frequency, rather than rely on a series of gears and pendulums. The period of vibration for a piezoelectric crystal depends on the size and shape of the crystal. While crystal oscillators are susceptible to temperature, humidity, pressure, and vibration fluctuations, their effects are much more controllable and correctable than their mechanical counterparts.

As a result of the foregoing, modern digital clocks are much more accurate timekeepers than analog clocks attached to mechanical clockworks. Digital clock displays, typically using light-emitting diodes (“LEDs”), liquid crystal displays (“LCDs”), or thin-film transistors (“TFTs”, a variant of LCDs) have become commonplace.

In summary, the current state of time-keeping finds that digital clocks are more accurate because the analog clocks with mechanical clockworks have to account for a number of sources of inaccuracy and energy loss: friction, inertia, thermal variation, wear, and gravity, inter alia. A mechanical clock needs to be wound, or have some other source of additive energy, because the spring force eventually is exhausted overcoming energy loss. Digital clocks use crystal oscillators, or other electronic circuitry, that do not have similar inaccuracies and energy losses. As a result of the higher accuracy, digital clock displays with electronic/piezoelectric movements are supplanting the ubiquity of analog clock displays with mechanical movements. Additionally, electronic/piezoelectric movements have been mated with analog clock displays.

Although people tend to prefer the aesthetics of an analog clock display, they prefer the accuracy and ease-of-use of electronic clockworks. The main failure mode of electronic clockworks is that the power can fail, causing someone to have to reset all the electronic clocks so affected. Additionally, when mated with an analog display, an electronic clockwork can be somewhat inaccurate, due to the tolerance inherent in the angular positioning of the hour and minute hand. What is needed is a way of automatically resetting an electronic clock with an analog display, so that the analog display is always accurate.

### PRIOR ART REVIEW

There is clearly a market demand for a clock with an analog display, that is accurate, that will reset after a power outage, and that does not need to be wound or otherwise attended to.

There is prior art related to master/slave arrangements of clocks, which attempt to meet this market demand, but all of them fall short. For example, U.S. Utility Pat. No. 8,934,321, by named inventor Fung, entitled, “Analog quartz timepiece and method for providing time-correction of the same,” teaches a quartz timepiece with an analog display that uses optics to detect the position of the hands, and then adjusts them to the correct. U.S. Utility Pat. No. 8,929,179, by named inventor Matsuo, entitled, “Analog electronic timepiece having rotating display bodies and a detection unit detecting when a rotating display body is in a predetermined reference display mode,” teaches a clock with an analog display in which the relative movement of the hands is detected and adjusted, so that the proper relationship between the two hands can be maintained. U.S. Utility Pat. No. 6,454,458, by named inventors Born, et. al., entitled, “Timepiece including means for indicating the angular position of coaxial analogue display indicators,” teaches the use of a magnetic or capacitive plate to detect the angular position of the two analog hands on an analog dial. U.S. Utility Pat. No. 6,343,050, by named inventor Kwok, entitled, “Analog clock driven by radio signals with automatic resetting means,” teaches using a digital clock as a master to an analog clock slave, feeding a time-signal from a time-keeping radio station to the master, and, then, adjusting the slave. U.S. Utility Pat. No. 5,422,863, by named inventors Minowa, et. al., entitled, “Automatically correcting electronic timepiece for selected signal receiving wireless receiver,” teaches a master/slave clock arrangement, wherein an electromagnetic signal is used to set the master and a time divider circuit is used to adjust the speed of the slave to synchronize with the master.

There is substantial additional prior art that teach things like master and slave clock arrangements. Some use an analog master to analog slave correction methods, with an analog display. Some use a digital master to analog slave correction methods, with an analog display. Some use a digital master to digital slave correction methods, with a digital display. What the market is looking for is the performance and ease of use of a digital master to digital slave correction topology, that is then converted to an analog display. Such a chronograph would give the market the aesthetics of an analog display, with the accuracy of a digital master and the ease of use of a digital slave

### SUMMARY OF THE INVENTION

This summary is intended to disclose the present invention, a chronograph employing a digital master clock that corrects a slave clock, wherein the angular position of the hands on an analog display are adjusted so that the slave clock corresponds to the digital master clock. The embodiments and descriptions are used to illustrate the invention and its utility, and are not intended to limit the invention or its use.

The present invention relates to a timepiece, including a clockwork movement, provided with an analogue display dial. A typical analogue display dial has at least twelve (12) equally spaced symbols or numbers, arranged in an approximately circular fashion. Two hands, or indicators, are attached to separate rotating shafts. One hand, the hour hand, marks the progression of hours, by moving one-twelfth ( 1/12) of the complete rotation in an hour. The other hand, the minute hand, marks the progression of minutes, by moving in a complete rotation in an hour, or one-sixtieth ( 1/60) of a complete rotation per minute. The hour hand is connected to a rotating shaft; the minute hand is attached to a separate, rotating shaft. The two rotating shafts share a common axis of rotation, with the minute hand shaft typically nested inside the hour hand shaft.

The present invention uses rotary digital encoders to identify the absolute angular position of the hour-hand shaft and minute-hand shaft, or the hour-hand and the minute hand. The present invention has at least one angular position digital encoder disk attached to the rotational shaft for the hour hand; and at least one angular position digital encoder disk attached to the rotational shaft for the minute hand. In one embodiment, the angular encoder disks are magnetic. In an alternative embodiment, the angular encoder disks are optical. The periphery of the hour shaft digital encoder disk has cogs (gear teeth) that mate with matching cogs on an hour-shaft driving motor. The hour-hand driving motor cogwheel drives the hour-hand digital encoder disk, which causes the hour-hand shaft to rotate. The periphery of the minute hand shaft digital encoder disk also has cogs that mate with a matching cogwheel on a minute-hand drive motor. The minute-hand drive motor cogwheel drives the minute-hand digital encoder disk, which causes the minute-hand shaft to rotate.

In the magnetic-encoder-disk embodiment, at least one surface of each encoder disk has a plurality of alternating (north and south) magnetic poles. The magnetic poles are radially arranged about the disk at six different radii. Each radii represents a bit of the encoder disk, allowing for a binary coded decimal (BCD) integer of up to 64. In one embodiment of the optical encoder disk embodiment, at least one surface of each encoder disk has a plurality of reflective regions. The plurality of reflective regions are designed to reflect a light source, such as a laser or LED, back to a photodiode detector. The plurality of reflective regions are radially arranged about the disk at six different radii. Each radii, again, represents one bit, allowing for a BCD integer of up to 64. In a second embodiment of the optical encoder disk, the surface of the encoder disk has a plurality of slits, holes, or optically transparent regions, allowing a light source, such as a laser or LED to shine through the disk to a photodiode detector. The optically transparent regions are radially arranged about the disk at six different radii, allowing for a BDC integer of up to 64.

In the magnetic encoder disk embodiment, a position sensor can detect the current position of the magnetic encoder disk, and therefore the drive shaft, by decoding the BCD in proximity to the position sensor. For a magnetic encoder disk, at least one magnetic field sensor, such as a Hall Effect sensor, a microelectromechanical sensor (“MEMS”), or other well-known magnetic pick-up sensors, can detect the BCD integer for the current position of the magnetic encoder disk. Likewise, in the optical encoder disk embodiment, a position sensor can detect the current position of the optical encoder disk, and therefore the drive shaft, by decoding the BCD integer in proximity to the position sensor. For an optical encoder disk, at least one light source, such as a laser or LED can be paired with at least one photodiode to detect the BCD for the current position of the optical encoder disk.

The BCD codes for the hour and minute shaft are combined and converted into a time code (hour:minute). The combined time code from the decoder disks is the slave time code. The slave time code is compared to a master time code with a comparator. When the slave time code matches the master time code, the output to the shafts drive motors is turned off. When the slave time code does not match the master time code, a feedback circuit causes the minute-hand drive-motor and/or the hour-hand drive motor to advance the digital encoder disk(s) until the clock hands are in the correct angular position, indicating that the clock is set at the correct time according to the master time code.

The master time code can be generated, internally, by a digital clockworks, using, for example, a piezoelectric oscillator. In the absence of an internal master time code, the master time code can be transmitted to the present invention from an external source, such as a cellphone or another clock. In this way, the timepiece can be automatically reset after a power outage, or when the time changes, such as daylight savings time. Additionally, the present invention can always be made to be synchronized with any clock used as a master clock.

Optionally, the invention can be expanded to also account for a second hand, by adding a second-hand, a second-hand encoder disk, a second-hand drive motor, and a second-hand rotary encoder, and adjusting the system logic accordingly.

### BRIEF DESCRIPTION OF THE DRAWINGS

The present invention is illustrated with 4 drawings on 5 sheets.

FIG. 1 is a side view of the present invention.

FIG. 2A is a top view of an optical encoder disk.

FIG. 2B is a side view of an optical encoder disk.

FIG. 2C is an isometric view of an optical encoder disk.

FIGS. 3A and 3B show block diagrams.

FIG. 4 is a top view of a magnetic encoder disk and an optical encoder disk.

### DETAILED DESCRIPTION OF THE DRAWINGS

The following descriptions are not meant to limit the invention, but rather to add to the summary of invention, and illustrate the present invention, a Digital-to-Digital Correction Unit for an Analog Clock Display. The Digital-to-Digital Correction Unit for an Analog Clock Display is a clock device with an analog clock dial and a digital-to-digital correction unit. The present invention is illustrated with a variety of drawings showing various possible embodiments.

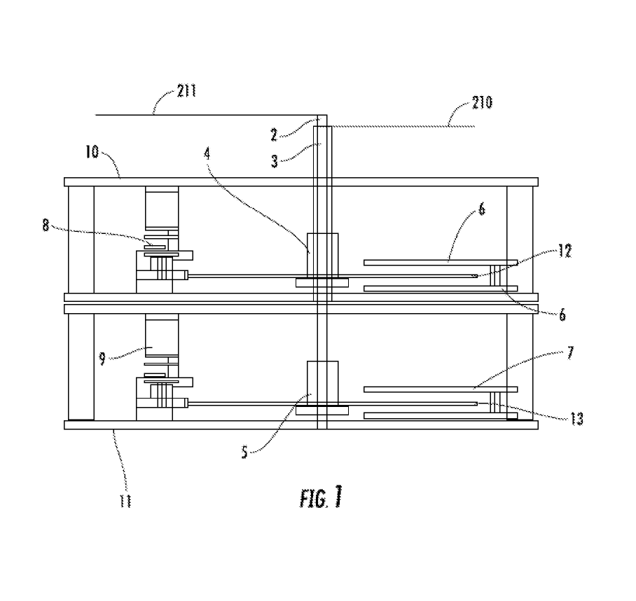

FIG. 1 shows a side view of the present invention. A minute-hand drive-shaft 2 is attached to a minute-hand encoder disk 13 with a non-slip coupling 5. Likewise, an hour-hand drive-shaft 3 is attached to an hour-hand encoder disc 12 with a non-slip coupling 4. The edge of the minute-hand encoder disk 13 has a plurality of cogs. The cogs on the edge of the minute-hand encoder disk 13 engage with cogwheel attached to minute-hand shaft drive-motor 9. The edge of the hour-hand encoder disk 12 has a plurality of cogs. The cogs on the edge of the hour-hand encoder disk 12 engage with a cogwheel attached to the minute-hand shaft drive-motor 8. The surface of the minute-hand encoder disk 13 is in proximity with a minute-hand sensor pick-up assembly 7 called a rotary encoder 7. The surface of the hour-hand encoder disk 12 is in proximity with an hour-hand sensor pick-up assembly 6 called a rotary encoder 6. The present invention has a base 11. The present invention also has an analog clock display 10.

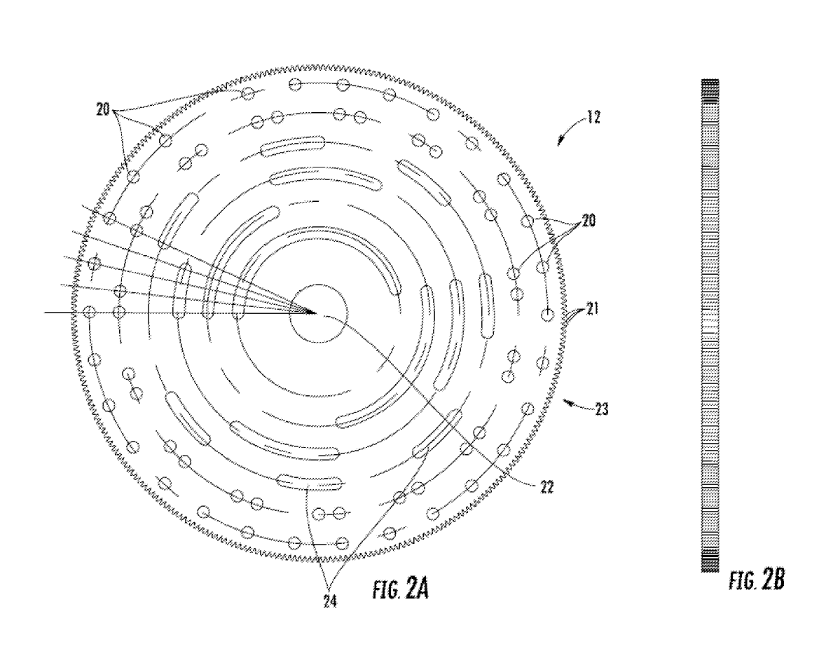

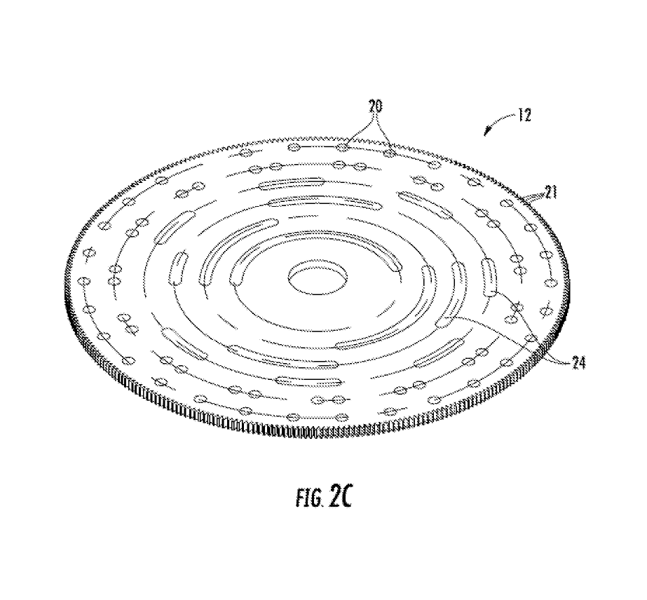

FIGS. 2A, 2B, and 2C show various views of an optical encoder disc 12. The surface of the optical encoder disc 12 has a plurality of reflective zones 20, 24, radially arranged about the disc 12. The reflective zones 20, 24 are positioned about six discrete radii. Some of the reflective zones 20 are circular. Some of the reflective zones 24 are elongated around the radius. The periphery 23 of the disk 12 has a plurality of cogs (teeth) 21. The center 22 of the disk 12 engages with a non-slip coupling 4 which durably attaches the disk 12 to the shaft 3.

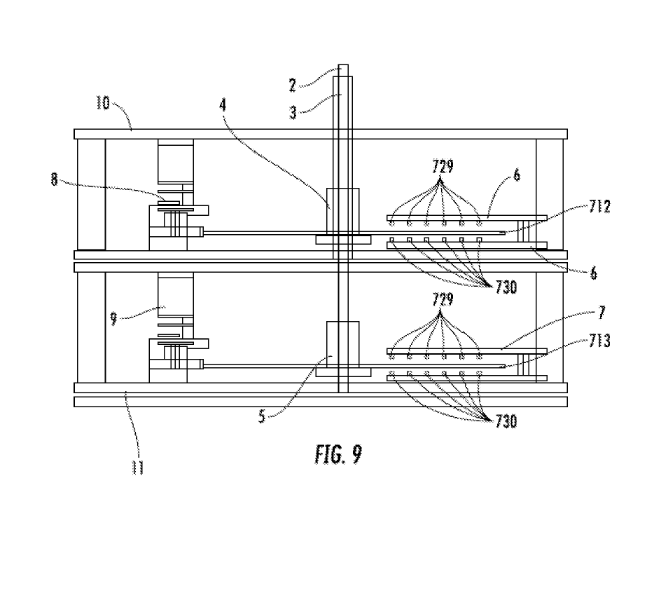

FIG. 4 shows a magnetic encoder disk 112 and an optical encoder disk 12, side-by-side. The magnetic encoder disk has a plurality of south poles 1 and north poles 0 arranged radially. A radial line 59 of radial bits 59 extending from the center to the outer periphery of the disk 112 runs through a plurality of poles 0, 1. The radial bits 59 create a BCD integer when read by a suitable pick-up device.

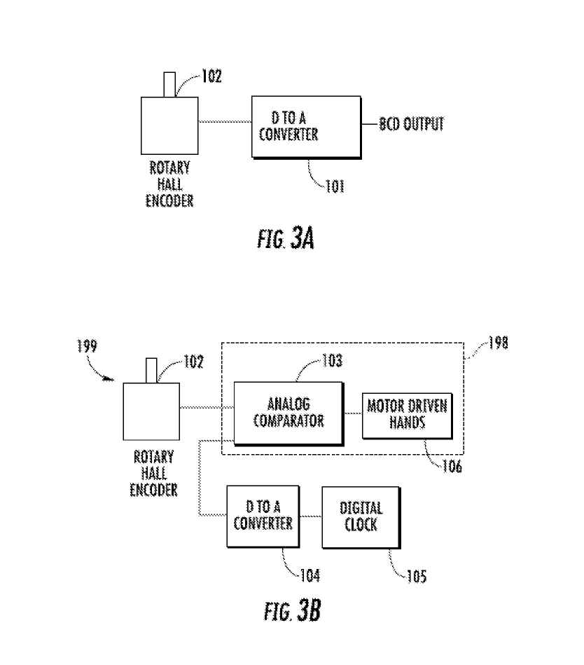

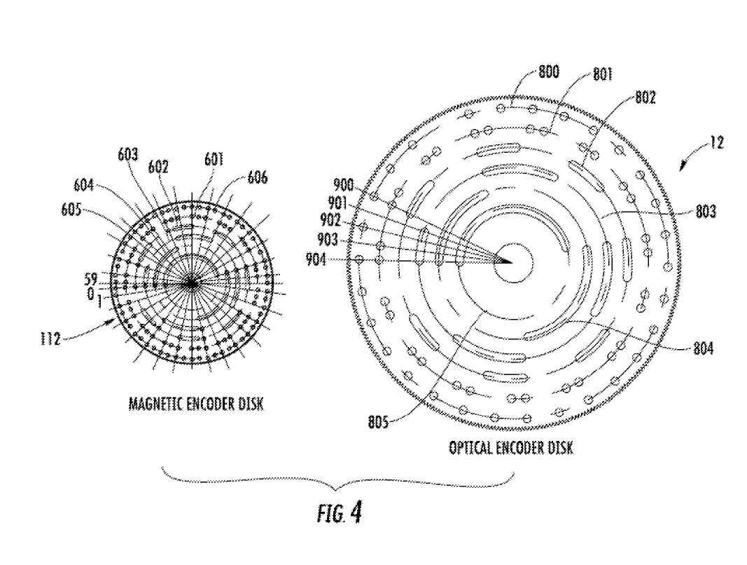

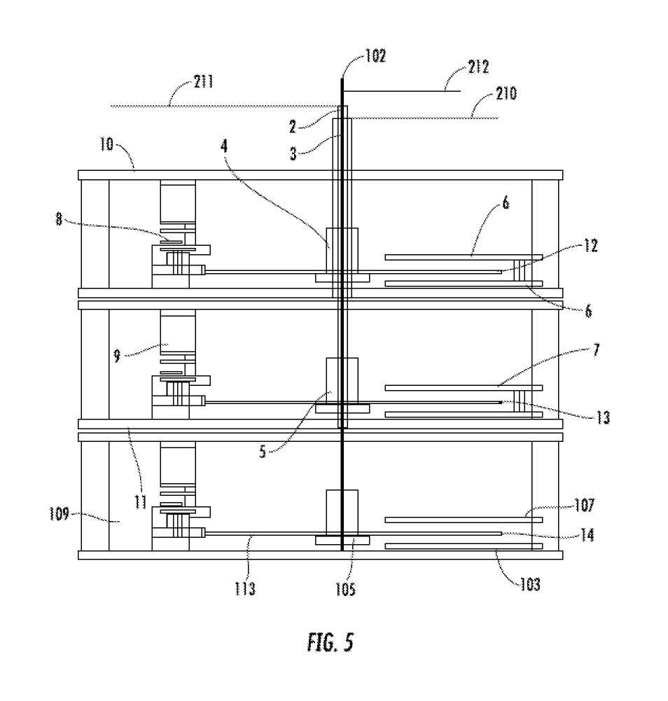

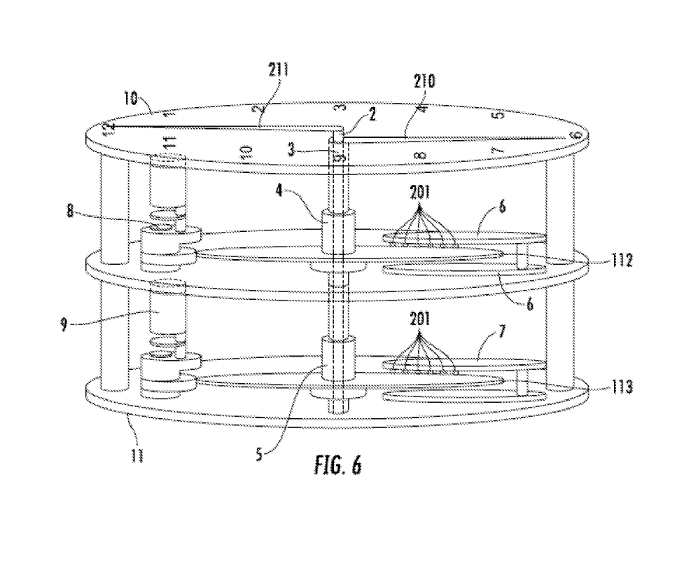

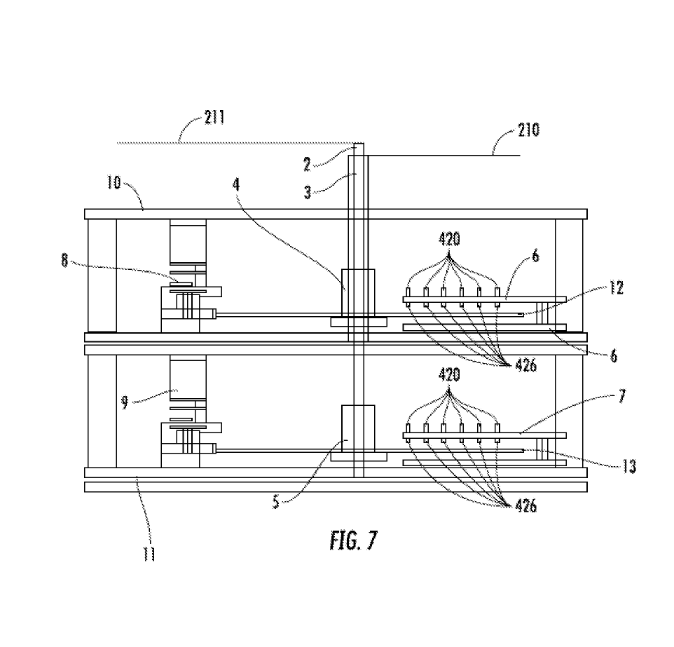

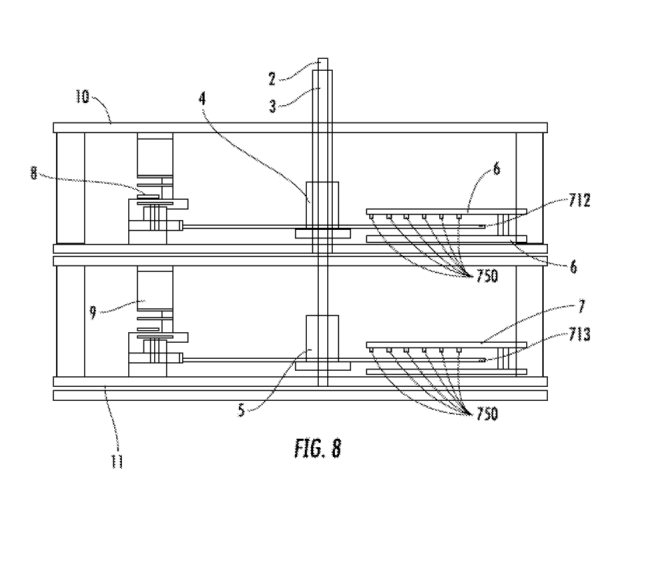

FIGS. 3A and 3B show block diagrams of the logic used in the magnetic-encoder-disk embodiment of the present invention. The rotary hall encoder 102 is used with a magnetic encoder disk 112, to read the radial bits 59. In FIG. 3A, by running the radial bits 59 through a digital to analog converter 101, the invention creates a BCD integer. The BCD integer can be logically converted into a time code (hours:minutes). The BDC integer from the rotary hall encoder 102, acting as a time code slave, is fed into a comparator 103. A time code master, from a digital clock 105 and a digital to analog converter 104 is also fed into a comparator. The results 103 is fed into a logic circuit that drives the motor driven hands 106. When the slave time code 101 and the master time code 104 are equal, the motors are not driven. When the slave time code 101 does not equal the master time code 104, the motors rotate the hands until the slave time code 101 equals the master time code 104.

The master time code 104 comes from a digital clock 105, which can either be internal to the present invention, or can be transmitted to the present invention from an external digital clock 105. This allows the present invention to (1) recover from a power outage; (2) adjust to daylight savings time; and (3) be synchronized with another clock. The present invention can incorporate a second-hand by adding to the mechanism a second-hand, a second-hand shaft, a second-hand coupling, a second-hand encoder disk, a second-hand drive motor, and a second-hand rotary encoder. The system logic, such as the time code (hour:minutes:seconds) would need to be adjusted to correctly incorporate a second hand.

I claim:

1. A clock device with an analog display and a time correction unit comprising an analog clock dial with an hour hand and a minute hand in proximity to, and parallel with, the clock dial;
an hour-hand shaft connected to and supporting the hour hand; a minute-hand shaft connected to and supporting the minute hand;
wherein the relative position of the hour hand and hour-hand shaft with respect to the analog clock dial is the angular position of the hour hand and hour-hand shaft; and wherein the relative position of the minute hand and minute-hand shaft with respect to the analog clock dial is the angular position of the minute hand and minute-hand shaft;
an hour-hand digital encoder disk with peripheral cogs, encoded with information identifying the angular position of at least one of the hour-hand and the hour-hand shaft; a minute-hand digital encoder disk with peripheral cogs, encoded with information identifying the angular position of at least one of the minute-hand and minute-hand shaft;
a first non-slip coupling, permanently attaching the center of the hour-hand digital encoder disk to the hour-hand shaft in a non-slip fashion; a second non-slip coupling, permanently attaching the center of the minute-hand digital encoder disk to the minute-hand shaft in a non-slip fashion;
an hour-hand drive motor, attached to the hour-hand digital encoder disk with a cogwheel; a minute-hand drive motor, attached to the minute-hand digital encoder disk with a cogwheel;
an hour-hand rotary encoder, comprised of at least one sensor capable of reading the angular position information from the hour-hand encoder disk; a minute-hand rotary encoder, comprised of at least one sensor capable of reading the angular position information from the minute-hand encoder disk;
a circuit that converts the angular position information from the minute-hand rotary encoder and the angular position information from the hour-hand rotary encoder into a slave time code;
a master time code from a digital clock source;
a feedback circuit that controls the speed of the minute-hand drive motor and the hour-hand drive motor, so that the slave time code continuously equals the master time code;
wherein the angular position information encoded on the minute-hand encoder disk is arranged in at least six concentric circles, with at least six discrete radii, corresponding to a BCD integer of at least six bits.; and
wherein the angular position information encoded on the hour-hand encoder disk is arranged in at least six concentric circles, with at least six discrete radii, corresponding to a BCD integer of at least six bits.

2. (canceled)

3. (canceled)

4. The clock device with an analog display and time correction unit of claim 1, wherein the hour-hand encoder disk stores angular position information on a readable magnetic substrate.

5. The clock device with an analog display and time correction unit of claim 4, wherein the at least one hour-hand rotary encoder sensor is a Hall Effect sensor.

6. The clock device with an analog display and time correction unit of claim 4, wherein the at least one hour-hand rotary encoder sensor is a microelectromechanical sensor (“MEMS”).

7. The clock device with an analog display and time correction unit of claim 4, wherein the minute-hand encoder disk stores angular position information on a readable magnetic substrate.

8. The clock device with an analog display and time correction unit of claim 7, wherein the at least one minute-hand rotary encoder sensor is a Hall Effect sensor.

9. The clock device with an analog display and time correction unit of claim 7, wherein the at least one minute-hand rotary encoder sensor is a microelectromechanical sensor (“MEMS”).

10. The clock device with an analog display and time correction unit of claim 4, wherein the minute-hand encoder disk stores angular position information on an optically readable substrate.

11. The clock device with an analog display and time correction unit of claim 10, wherein the at least one minute-hand rotary encoder sensor uses at least one LED and at least one photodiode.

12. The clock device with an analog display and time correction unit of claim 10, wherein the at least one minute-hand rotary encoder sensor uses at least one laser and at least one photodiode.

13. The clock device with an analog display and time correction unit of claim 1, wherein the hour-hand encoder disk stores angular position information on an optically readable substrate.

14. The clock device with an analog display and time correction unit of claim 13, wherein the at least one hour-hand rotary encoder sensor uses at least one LED and at least one photodiode.

15. The clock device with an analog display and time correction unit of claim 13, wherein the at least one hour-hand rotary encoder sensor uses at least one laser and at least one photodiode.

16. The clock device with an analog display and time correction unit of claim 13, wherein the minute-hand encoder disk stores angular position information on a readable magnetic substrate.

17. The clock device with an analog display and time correction unit of claim 16, wherein the at least one minute-hand rotary encoder sensor is a Hall Effect sensor.

18. The clock device with an analog display and time correction unit of claim 16, wherein the at least one minute-hand rotary encoder sensor is a microelectromechanical sensor (“MEMS”).

19. The clock device with an analog display and time correction unit of claim 13, wherein the minute-hand encoder disk stores angular position information on an optically readable substrate.

20. The clock device with an analog display and time correction unit of claim 19, wherein the at least one minute-hand rotary encoder sensor uses at least one LED and at least one photodiode.

21. The clock device with an analog display and time correction unit of claim 19, wherein the at least one minute-hand rotary encoder sensor uses at least one laser and at least one photodiode.

22. The clock device with an analog display and time correction unit of claim 1,
further comprising a second-hand, a second-hand shaft, a second-hand coupling, a second-hand encoder disk, a second-hand drive motor, and a second-hand rotary encoder; and
wherein the angular position information encoded on the second-hand encoder disk is arranged in at least six concentric circles, with at least six discrete radii, corresponding to a BCD integer of at least six bits.
